(19) United States
(12) Patent Application Publication
(10) Pub. No.: US 2002/0149714 A1
(43) Pub. Date: Oct. 17, 2002

(54) Ruggedized flat panel display assembly

(76) Inventors: Robert Anderson, Cumming, GA (US); David Warren, Flowery Branch, GA (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 09/835,952

(22) Filed: Apr. 16, 2001

(51) Int. Cl. G02F 1/1333

(52) U.S. Cl. 349/59

(57) ABSTRACT

A ruggedized flat panel display assembly that protects a relatively fragile flat panel display from potentially damaging mechanical shock energy. This system adds stability to a flat panel display without introducing optical defects and requiring extended curing periods. Generally described, the ruggedized flat panel display assembly includes a flat panel display, an external frame supporting the flat panel display, and a resilient adhesive element for securing the flat panel display to the external frame and for dampening the communication of mechanical shock energy from the external frame to the flat panel display.

### TECHNICAL FIELD

The present invention relates generally to display systems, and more particularly, to a ruggedized flat panel display.

### BACKGROUND OF THE INVENTION

Cathode ray tubes (CRTs) and flat panel displays dominate the industry in the display of electronic information. Television sets and computer monitors often include CRTs that produce desired colors by mixing red, green and blue light. CRTs can produce images with accurate color representation and good intensity. However, CRTs use a tube that typically requires considerable depth.

In contrast, flat panel displays require very little space. This enables use of flat panel displays in environments with substantial space restrictions, such as avionics. Unfortunately, the components in many flat panel displays can be relatively fragile. This can inhibit the use of flat panel displays in military environments that could expose these displays to substantial vibrations and mechanical shock.

In the past, it has been known to stabilize (ruggedize) a flat panel display by laminating additional layers of coated glass to the front of the flat panel display. FIG. 1 illustrates a conventional prior art ruggedized flat panel display 100 with coated glass layers 101-104 placed in front of the liquid crystal layer 110. The resulting ruggedized flat panel display 100 possesses greater mass and rigidity than the individual liquid crystal layer 110. This increase in mass correspondingly increases the bulk strength of the associated display. Consequently, the massive ruggedized flat panel display 100 can withstand greater vibrations and mechanical shock. Thus, addition of the layers creates a ruggedized display.

To create the ruggedized display 100, manufacturers typically laminate each of the layers 101-104 against the liquid crystal layer 110 or one of the coated layers. For example, the layer 104 is laminated to the liquid crystal layer 110, while the layer 103 is laminated to the layer 104. This lamination process necessitates precise alignment and extended curing times for each layer and additional cost. Thus, creating a substantially ruggedized flat panel display by adding large numbers of coated layers can require considerable time.

In addition to this time demand, lamination techniques can produce adverse optical effects. For example, light emanating from the liquid crystal layer 110 encounters a junction at the intersection of liquid crystal layer 110 and the coated layer 101. If the optical properties on each side of this junction differ, reflections can change the intensity of the transmitted light. The intensity can decrease further as the transmitted light traverses the junction between coated layers 101 and 102. As the number of layers increase, the amount of light loss between layers also increases. Moreover, any decoupling delaminations and “picture-framing” effects can create additional problems. Consequently, ruggedizing flat panel display by using laminations can result in numerous adverse optical effects.

Despite the development in the area of somewhat ruggedized flat panel displays, conventional solutions are costly and fail to reduce optical defects resulting from using lamination techniques. In particular, larger ruggedized flat panel displays are very costly and problematic to produce using conventional laminating techniques, thereby posing unacceptable manufacturing yields. Thus a need still exists for a lower cost ruggedized flat panel display assembly that avoids creating optical defects.

### SUMMARY OF THE INVENTION

The present invention meets the needs described above in a ruggedized flat panel display assembly that protects a relatively fragile flat panel display from potentially damaging mechanical shock energy. The invention adds stability to a flat panel display without introducing optical defects, and without requiring precision manual alignment techniques or requiring extended curing periods.

Generally described, a first preferred form of the invention is a ruggedized flat panel display assembly that includes a flat panel display and an external frame for supporting the flat panel display. This assembly also includes a resilient adhesive element for securing the flat panel display to the external frame and for dampening the communication of mechanical shock energy from the external frame to the flat panel display. Preferably, the adhesive element comprises an adhesive tape including a foam component.

A second preferred form of the invention is a ruggedized flat panel display assembly that includes a flat panel display and an external frame for supporting the flat panel display. The assembly form further includes transparent protective panels to the front and rear and a resilient adhesive element for securing the flat panel display to the external frame and for dampening the communication of mechanical shock energy from the external frame to the flat panel display. Preferably, the adhesive element comprises an adhesive tape including a foam component.

A ruggedized flat panel display assembly according to the present invention possesses substantial advantages over prior art devices. The present invention can be used in weight and space restrictive environments by ruggedizing without substantially increasing mass. In addition, the present invention minimizes cost. Moreover, the frame elements can include screw holes or gasket grooves that aide in mounting. Finally, the invention also allows ease of assembly by using a self-fixturing frame element.

These and other objects, features, and advantages of the present invention will become apparent upon reading the following specification in conjunction with the accompanying drawing figures.

### BRIEF DESCRIPTION OF THE DRAWINGS

FIG. 1 is a cross sectional view of a conventional prior art ruggedized flat panel display.

FIG. 2A is a cross sectional view of a first embodiment of a ruggedized flat panel display assembly in accordance with the invention.

FIG. 2B is a cross sectional view of a second embodiment of a ruggedized flat panel display assembly illustrating transparent protective panels.

FIG. 3 is a cross sectional view of a third embodiment of a ruggedized flat panel display assembly illustrating vibration isolators for use with an enclosure.

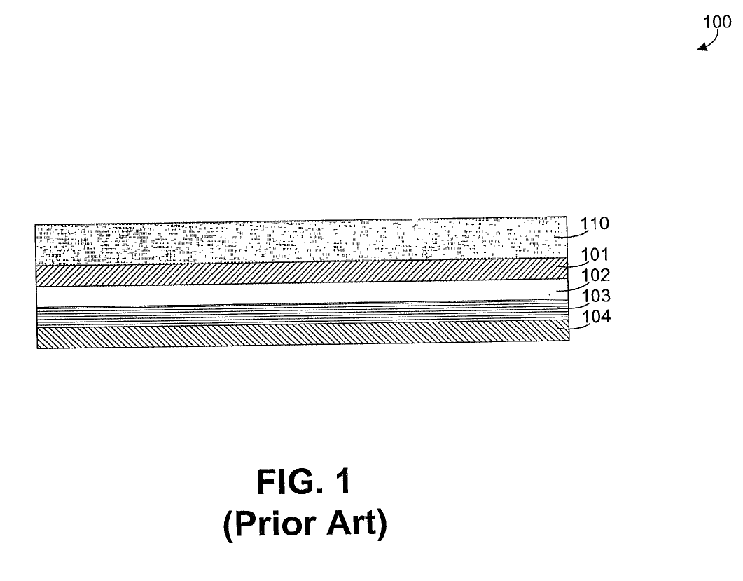

### DETAILED DESCRIPTION OF THE PREFERRED EMBODIMENTS

In describing the embodiments of the present invention, specific terminology is employed for the sake of clarity. The invention, however, is not intended to be limited to the specific terminology so selected.

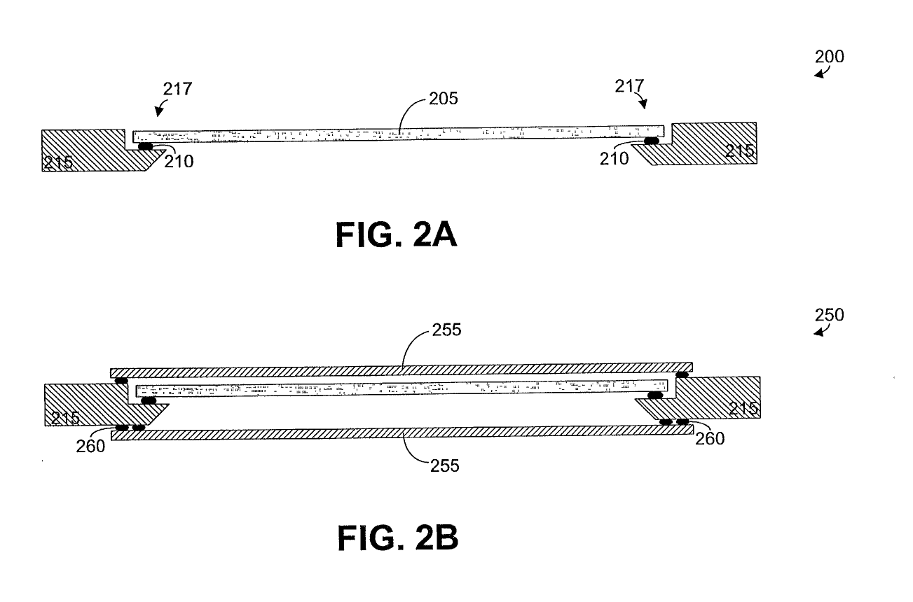

Referring now in detail to the drawings, wherein like reference numerals represent like parts throughout several views, FIG. 2A is a cross-sectional view of a first embodiment of a ruggedized flat panel display assembly 200 in accordance with the present invention. The display assembly 200 includes a flat panel display 205. The display 205 can be a liquid crystal display, for example, or any other similarly functioning display. Several resilient adhesive elements 210 secure the display 205 to an external frame 215. The adhesive elements 210 can include double-sided foam tape or a resilient adhesive. If desired, the adhesive elements could also include silicone rubber adhesive, double-sided acrylic foam tape, polysulfide compound, or flexible epoxy adhesive. The frame 215 can be metal, such as stainless steel. Other metals with similar properties can also be used.

The resilient adhesive elements 210 aid in protecting the relatively fragile liquid crystal display 205 from potentially damaging mechanical and thermal shock energy without substantially increasing mass. Initially, the frame 215 absorbs a portion of the mechanical shock energy, which prevents passage of this energy to the display 205.

The resilient adhesive element 210 further absorbs a substantial portion of remaining mechanical shock energy before it reaches the display 205. Consequently, mechanical shock energy that reaches the display 205 tends to be within defined acceptable ranges. Since the resilient adhesive elements 210 dampen mechanical shock energy, their use in combination with the external frame 215 creates the ruggedized display 200. In addition, the resilient adhesive elements 210 secure the frame 215 to the flat panel display 205. The resilient adhesives 210 also absorb stresses induced by differences in thermal expansion between glass display 205 and metal frame 215. Light emanating from the ruggedized display 200 can propagate essentially uninhibited to its destination. As a result, the ruggedized display assembly 200 avoids the optical defects inherent in conventional ruggedized displays that use lamination techniques.

FIG. 2B is a cross-sectional view of a second embodiment of a ruggedized flat panel display assembly 250 illustrating transparent protective panels. This display assembly includes transparent protective panels 255 secured to front and rear faces of the frame 215 by several resilient adhesive elements 260. These adhesive elements can be double-sided tape with a foam layer, for example. The protective panel 255 can be a glass panel, acrylic panel, polycarbonate panel, or some other suitable panel.

Adding the protective panels 255 can improve environmental immunity by protecting the display 205 from humidity and accidental punctures, for example. Moreover, the optical properties of this panel can be selected so as to minimize optical defects. For example, constructing the protective panel 255 with a particular index of refraction can minimize optical defects.

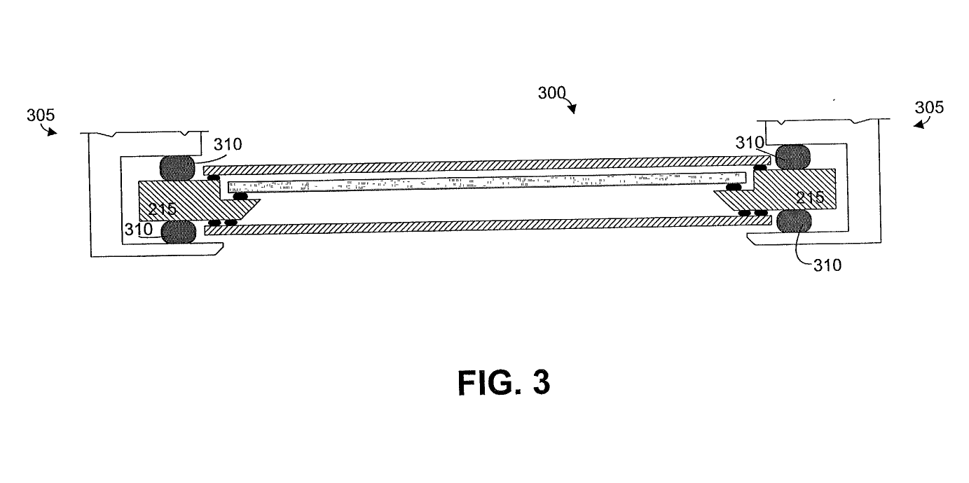

FIG. 3 is a cross sectional view of a third embodiment of a ruggedized flat panel display assembly 300 illustrating vibration isolators for use with an enclosure. This display assembly includes vibration isolators 310 that secure the display assembly 300 to the enclosure 305. These vibration isolators can be made of a resilient material, such as energy absorbing foam or very low durometer rubber. The resiliency of the vibration isolators dampens mechanical shock energy in this enclosure before it is communicated to the frame 215. The enclosure 305 could be an avionic enclosure that enables mounting the flat panel display assembly 300 in an aircraft.

A ruggedized flat panel display assembly in accordance with the invention protects the relatively fragile flat panel display from potentially damaging mechanical shock energy. The invention adds stability to a flat panel display by using a low-cost resilient adhesive element. Use of these elements avoids introducing optical defects. In addition, the self-fixturing nature of the resilient adhesive elements avoids the precision alignment needed in typical prior art displays. The frame can be machined to incorporate useful details such as screw holes, grooves, and counterbores. Moreover, flat panel displays prepared in accordance with this invention can also be illuminated with a custom lighting source enabling the displays usage in extreme lighting conditions, such as full sunlight or with night vision gear. As a result, a flat panel display assembly, in accordance with the invention, substantially improves yield and ease of assembly.

In view of the foregoing, it will be appreciated that present invention provides a ruggedized flat panel display assembly. It should be understood that the foregoing relates only to the exemplary embodiments of the present invention, and that numerous changes can be made therein without departing from the spirit and scope of the invention as defined by the following claims.

The invention claimed is:

1. A ruggedized flat panel display assembly, comprising:
a flat panel display;
an external frame for supporting said flat panel display; and
a resilient adhesive element for securing said flat panel display to said external frame and for dampening the communication of mechanical shock energy from said external frame to said flat panel display.

2. A ruggedized flat panel display assembly as in claim 1 wherein said flat panel display comprises a liquid crystal display.

3. A ruggedized flat panel display assembly as in claim 1 wherein said external frame is rigid.

4. A ruggedized flat panel display assembly as in claim 1 wherein said adhesive element absorbs thermal expansion mismatches between said flat panel display and said external frame.

5. A ruggedized flat panel display assembly as in claim 1 wherein said adhesive element comprises double-sided foam tape.

6. A ruggedized flat panel display assembly as in claim 1 further comprising protective transparent panels secured to said external frame.

7. A ruggedized flat panel display assembly as in claim 6 wherein said protective panels comprise a glass panel.

8. A ruggedized flat panel display assembly as in claim 6 wherein said protective transparent panels comprises an acrylic panel or a polycarbonate panel.

9. A ruggedized flat panel display assembly as in claim 1 and wherein said ruggedized flat panel assembly is for use in an enclosure, said assembly further comprising a plurality of vibration isolators positioned between said external frame and the enclosure, said vibration isolators further dampening the communication of mechanical shock energy from the enclosure to said external frame.

10. A ruggedized flat panel display assembly, comprising:
a flat panel display;
an external frame for supporting said flat panel display;
a resilient adhesive element for securing said flat panel display to said external frame and for dampening the communication of mechanical shock energy from said external frame to said flat panel display; and
first and second transparent protective panels secured to front and rear faces of said external frame.

11. A ruggedized flat panel display assembly as in claim 10 wherein said flat panel display comprises a liquid crystal display.

12. A ruggedized flat panel display assembly as in claim 10 wherein said external frame comprises stainless steel.

13. A ruggedized flat panel display assembly as in claim 10 wherein said adhesive element comprises a layer of resilient adhesive.

14. A ruggedized flat panel display assembly as in claim 10 wherein said adhesive element comprises double-sided foam tape.

15. A ruggedized flat panel display assembly as in claim 14 wherein said protective panel comprises a glass panel.

16. A ruggedized flat panel display assembly as in claim 10 and wherein said ruggedized flat panel display assembly is for use in an enclosure, said assembly further comprising a plurality of vibration isolators positioned between said external frame and the enclosure, said vibration isolators further dampening the communication of mechanical shock energy from the enclosure to said external frame.

17. A ruggedized flat panel display assembly, comprising:
a liquid crystal display;
an external frame for supporting said liquid crystal display;
a resilient adhesive element for securing said liquid crystal display to said external frame and for dampening the communication of mechanical shock energy from said external frame to said liquid crystal display; and
first and second transparent protective panels secured to front and rear faces of said external frame for providing higher levels of environmental immunity.

18. A ruggedized flat panel display assembly as in claim 17 wherein said external frame comprises stainless steel.

19. A ruggedized flat panel display assembly as in claim 17 wherein said adhesive element comprises a resilient adhesive.

20. A ruggedized flat panel display assembly as in claim 17 wherein said adhesive element comprises double-sided foam tape.
